(19) United States
(12) Patent Application Publication
(10) Pub. No.: US 2003/0093412 A1
(43) Pub. Date: May 15, 2003

(54) Global recuresive and scalable database management system

(76) Inventor: Nishan Mark Urkumyan, San Jose, CA (US)

Correspondence Address: ROBERT SAMUEL SMITH, 1263 EMORY ST., SAN JOSE, CA, 95126, US

(21) Appl. No.: 09/992,401

(22) Filed: Nov. 13, 2001

(51) Int. Cl. G06F 7/00

(52) U.S. Cl. 707/3

(57) ABSTRACT

A method and apparatus for accessing a recursive scalable database in a multidimensional hierarchy through World Wide Web Internet communication channels to create, store, retrieve, manipulate, update and delete database objects that include records, audio, video and image data. Every time a file is to be restored in database memory (either a new file or a modified file) a pointer for storing the file is created which includes a file tag, derived from user identification data, and a new address in database memory to prevent any form of overflow. Space at the new memory address is selected to accommodate any size change of the modified file, permitting the storage area to expand. Thereby conferring the recursive scalable characteristic on the system

### FIELD OF THE INVENTION

This invention relates to database management systems and particularly to a method and apparatus for accessing a recursive scalable database in a multidimensional hierarchy through World Wide Web Internet communication channels to create, store, retrieve, manipulate, update and delete database objects that include records, audio, video and image data.

### BACKGROUND AND INFORMATION DISCLOSURE

In the context of this specification, the term “subject” will be understood to mean a collection of interrelated information. Many techniques have been developed to organize and present the related information of a subject into a form that enables retaining, manipulating, adding and sharing the information. These functions are performed by data base management systems (DBMS) adapted to computer technology.

The “database management system” (DBMS) is a computer system in which is installed all of the data of a database (subject) and the software for “operating” the database. The DBMS also includes a system of interfaces by which the system can be entered by a user seeking data and a “database manager” who has the responsibility of maintaining the operation of the DBMS.

In DBMS, information pertaining to any one subject is separable into distinct groups called “entities” or files. Each group member of an entity is called a “tuple”. All tuples of an entity are defined by a list of “attributes” (properties). Any one attribute has a value selected from a domain (group of values) that pertain to that attribute. In any given entity, all tuples have the same attributes but the value of an attribute for one tuple in general differs from the value of the same attribute of another tuple.

The earliest DBMS were “relational”.(RDBMS). In RDBMS, each entity (file) consists of a table of data arranged in rows and columns. Each row is a record of values (data) of the attributes of a single tuple. The list of all the tuples forms the table of values for all the tuples. The value of any attribute is changed by commands (operations) that were not included within the file.

The problem with the RDBMS is that the database memory is not scalable, meaning that the memory has a fixed number of addresses and a fixed number of attributes so that was no way to add more addresses beyond the capacity of the initial memory nor is there anyway to add or delete an indefinite number of attributes in accordance with changing circumstances.

Another problem with the RDBMS of the present art is its nonrecursive character. This means that if a change were required to be made in the attribute structure of a limited number of tuples, then the same change must be made in the attribute structure of all the tuples. These changes require a lot of computer time (and expense) to change the attribute structure of many tuples that would never be used and therefore were unnecessary.

In “object” database management systems (ODBMS), an “object” replaces a record. An object contains instructions to perform operations on data within the object thereby creating new data. In the context of the present specification, a file is an entity that generally contains at least one object. A file may contain only one object in which case the term “file address” is synonymous with “object address”. Concurrent with the development of the DBMS has been the development of the INTERNET, which is a system for transmitting data on a worldwide scale. The Internet is an array of computer installations (clients), all connected to communicate with one another through a network. Each client has his own address (URL). An INTERNET SERVER is a central computer and “traffic director” that connects any one of the clients with any other client by identifying the URLs of each node.

A client who requires information concerning a subject of interest can use either one of two methods for obtaining information.

According to one method, if he knows the domain name (URL) of a web member who has information, then he sends the URL to his server. The server sends the URL to a domain name server which is a directory that lists all of the domain names with a numeric address of the location of the owner of the URL. The server receives an “I.P.” address and contacts the target server. The target server sends website pages to the client through the WWW (world widw web) network.

According to a second method, a :browser is a software program stored on the client's computer. The client prompts the browser program to connect his computer to a search engine on the server. Then he enters a keyword in his computer. The browser sends the keyword to the search engine on the server. The search engine is a large directory of keywords with a group of URLs associated with the client's key word. The selected group of URLs is sent through the WWW network by the search engine to the browser for inspection by the client. The client selects the URL of most interest and sends the URL through the WWW network to the domain name server who matches the URL with a numeric address of the target (domain site of the URL). The target sends the website information through the WWW network back to the client computer.

A number of disclosures have appeared that combine the information retaining capabilities of the DBMS with the information distributing capability of the Internet.

For example, U.S. Pat. No. 6,178,419 to Smith discloses a method of automatically creating a database on the basis of a set of category headings using a set of keywords provided for each category heading. The key words are used by a processing platform to define searches carried out on a plurality of search engines connected to the processing platform via the Internet. The search results are processed by the processing platform to identify the URLs embedded in the Internet.

U.S. Pat. No. 6,125,209 to Doricott discloses an apparatus for accessing a database having database records comprising data compressed image data and including a client means for retrieving, and decompressing and storing data-compressed images in a data cache. The database server returns the data compressed images relating to database records.

### SUMMARY OF THE INVENTION

It is an object of this invention to provide a database system which will accept insertion of additional records and allow removing excess records dynamically and will not cause overflow or underflow of data which, in systems of the present art, split the records of the memory pages during the process of database management.

This invention is directed toward a method for mapping database information through the World Wide Web into multidimensional servers and simultaneously sending operations through the multidimensional hierarchy thereby providing a database management system that is recursive, scalable and multidimensional.

This object is not met by databases of the present art which maintain a separate memory area in reserve to store a group of destination addresses and keywords belonging to a predetermined subject category.

It is a further object of the invention to provide a database system, which enables n-dimensional information to be mapped into one-dimensional memory and, conversely, enables retrieval of information from memory relating to a specified point in n-dimensional space.

This invention is directed toward a program in a computer for mapping database information through the World Wide Web into multidimensional servers and for sending operations spontaneously through the multidimensional hierarchy of the Internet thereby providing a database management system that is recursive, scalable and multidimensional. The program is referred to herein as the “Creator” program.

Each node in the hierarchy is a file in the database memory reposing in a data storage area. The files are arranged as groups of one or more database objects wherein each file is stored in a section (of data storage). Groups of sections make up a segment. Groups of segments make up a partition. A partition typically, but not always, occupies a single server.

Every time, when it is required to store a file in data base memory (either when a new file is created or an existing file has been withdrawn for modification), a new pointer for each file of objects is created dynamically from a “tag” created from keywords entered as identifier information by the user and an available address in database memory selected by Creator program. The pointer is the key to access a database location. By dynamically is meant that, every time a new file is created or an existing file is accessed, a new pointer is created for that file using the original “tag” (identifier information) and a new address in the database memory. Any “old” pointer of an existing file is deleted.

The user, over time, adds more and more information causing existing objects of files to grow and/or new objects are added thereby causing the partition containing the objects to grow. When the partition outgrows the capacity of the server, the partition is divided into parts that are distributed among a group of servers.

Greatest efficiency in the operation of the database system is achieved when database objects having the same characteristics are located in the same section. The section has no limit of size, depth or definition and can eventually grow to a size wherein the number of files within a section can occupy a server in the World Wide Web Internet communication channel and, eventually, more than one server.

Each database object contains a set of data entries. Each data entry may or may not contain a value or set of values.

Each database object of a file in the hierarchy is recursively updated, redefined and restored as appropriate when new database objects are added to related or existing database objects or existing database objects are modified anywhere in the hierarchy.

The multidimensional scalable database hierarchy does not have a fixed size nor a fixed number of nodes. Database structures are created dynamically and are added to the hierarchy.

Each pointer points to a file of one or more objects in the scalable multidimensional hierarchy by pointing to the partition (server), segment of the partition and section of the segment in which the file is stored.

Parallel processing applied to systems of more than one server significantly increases the speed of search and fined operations.

### BRIEF DESCRIPTION OF THE DRAWINGS

FIGS. 1 and 2 are flowcharts that illustrate principle of the operation.

FIG. 3 shows sections of a program/computer for operating the creator program.

FIG. 4 shows adaptation to a multiserver hierarchy.

FIG. 5 shows partition structure of a single partition

FIG. 6 shows arrangement of multipartitions.

FIG. 7 shows format of the object.

FIG. 8 shows steps in performing the method of the invention.

### DESCRIPTION OF A BEST MODE

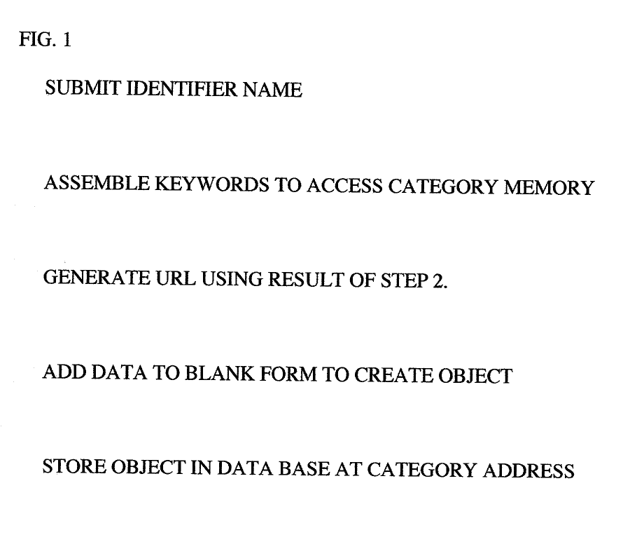

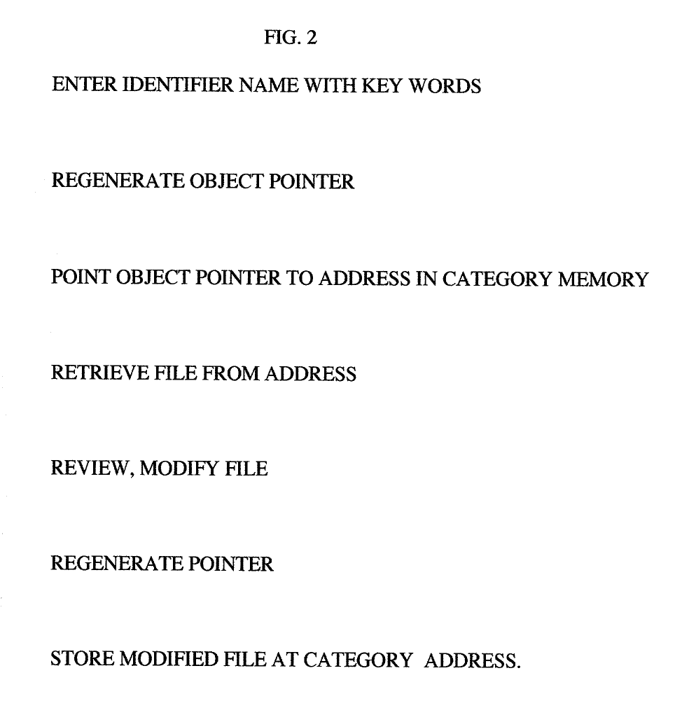

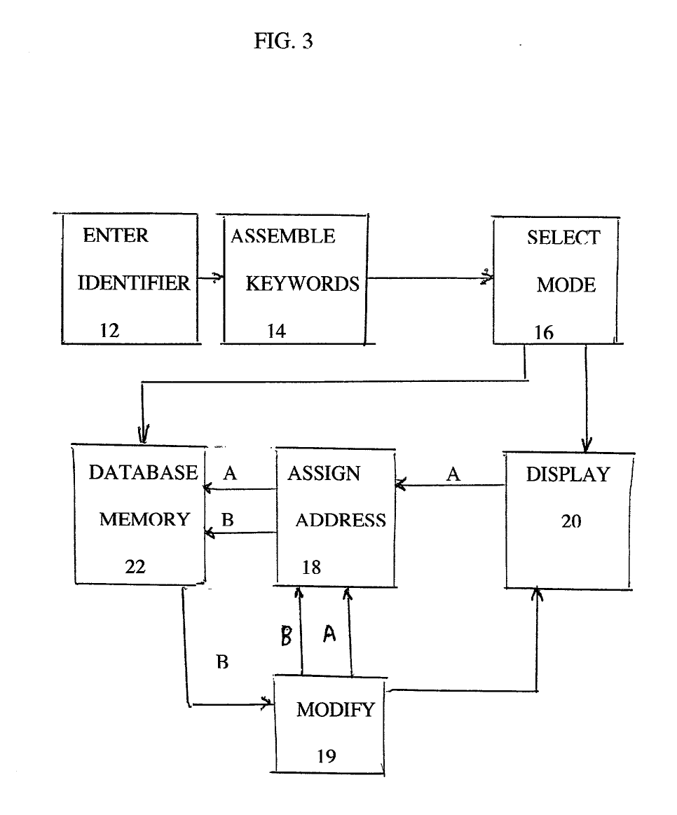

Turning now to a discussion of the drawings, FIGS. 1 and 2 are flow charts that illustrate general principles of the invention. The overall object of the user of the invention is either one of

I To create a file for storing data (FIG. 1).

II To review and modify data stored in any one of the files (FIG. 2)

The user has an “identifier” name that includes key words related to the nature of the file and/or title of the file or to features of the user such as web address, etc.

To create a file (FIG. 1):

In step 1, the user submits his identifier name to the system

In step 2, keywords from the identifier name are used to assemble a “tag”.

In step 3, an available file address in database memory is selected. The tag and the file address become a unique pointer which points to the file address in database memory where a newly created file is to be stored. As more files are created and stored, the tag represents only one file that is unique per user.

In step 4, a “form” is presented (a blank data object with no data.) which the user fills in with data. A collection of such (one or more) objects represents the new file.

In step 5, the completed file is stored in the database memory at the file address contained in the pointer.

To review and modify a file stored in database memory—(FIG. 2)

In step 1 the user enters his/her identifier name which includes the keywords.

In step 2, a tag is generated using the keywords from the identifier name which is used to locate the pointer (including the tag and file address) stored in category memory.

In step 3 the file is retrieved from the database memory using the file address identified by the pointer.

In step 4 the retrieved file is reviewed and modified as required.

In step 5, a new pointer is generated using the tag and a new (available) file address assigned for storing the modified file in database memory. The newly assigned memory space is sufficiently large to store an object enlarged by the modification step. The tag (keywords of identifier name) are retained in category memory with the new file address included. The file address p to modification is deleted

In step 6, the retrieved file is returned to the new file address in database memory;

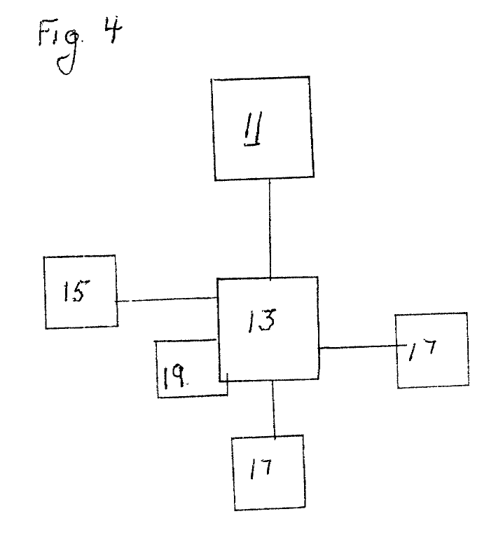

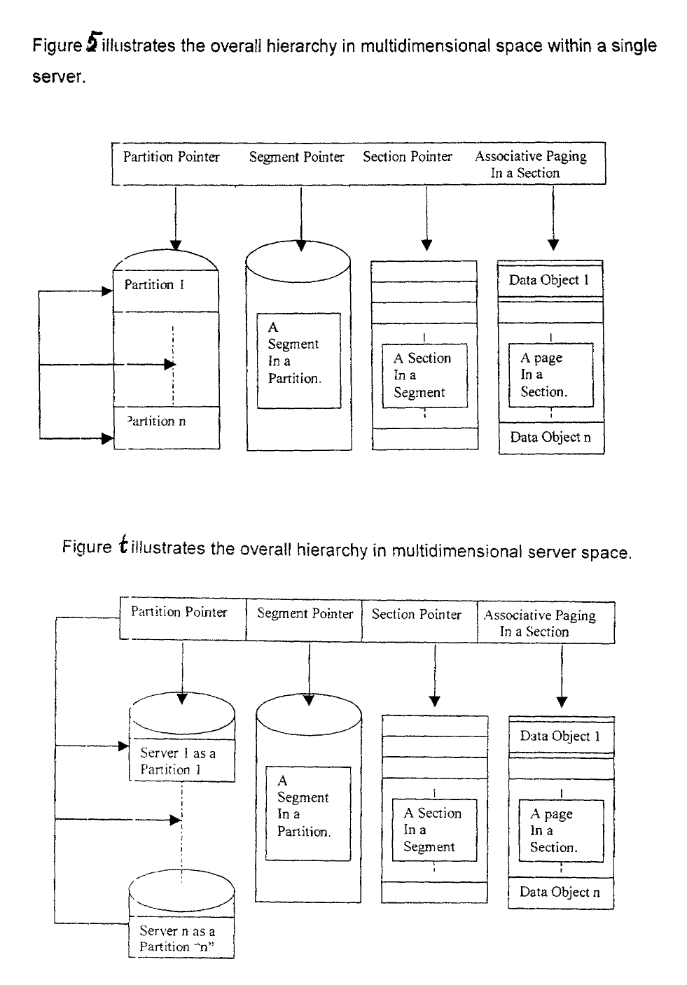

FIG. 3 illustrates components of the creator program for implementing the methods of FIGS. 1 and 2 includes:

A means 12 (typically a keyboard) for enabling a user to enter an identifier name containing keywords into the system.

Tag generator 14 for assembling the keywords into a tag.

A selector menu 16 for permitting the user to select one of (A) adding a new file and (B) reviewing and modifying a file existing in database memory.

A display 20 (typically a monitor) for:

(A) displaying blank object forms;

(B) displaying the selected file of objects to be viewed or modified.

A means 19 for recursively modifying a file selected from database memory by the user.

A pointer generator 18 combines the tag with an available (new) address in database memory thereby generating a pointer for storing a new file when (A) has been selected or for storing a modified file when (B) is selected. The memory section identified by the new address is selected to be sufficiently large to store any size file resulting from changes to the original file.

A data base memory 22 for storing the object pointed by the tags generated by pointer generator 18

The recursive dynamic scalable characteristic of the database system resides in the fact that a new address is assigned to the file when the file is newly created or when an existing file is modified or viewed and then restored to database memory. The advantage of selecting a new address is that the new location is sufficiently large to accommodate any increase or change in the file.

The apparatus for carrying out this invention can be assembled in a number of forms, all of which are within the scope of the invention. For example, in various embodiments, the display device is a paper document delivered by a facsimile machine coupled to a computer. In another version, the display device is an audio speaker. Another version is a VCR delivering a file as a combination of audio and video.

In one embodiment, the database memory is a card catalog and the keyword memory is a card index, the means for entering the identifier name is a type writer. The means for retrieving is a card sorter.

Another embodiment of the invention is a computer programmed to perform the steps listed in FIGS. 1 and 2 and having the sections illustrated in FIG. 3. In this scenario, the file is a collection of one or more “objects”

In one version,

the data base system including the database memory is entirely self contained in a single computer along with the Creator program.

In another version.

users computer is connected to the World Wide Web (WWW) through a server. The entire creator program (except for the database memory) resides in the users computer and creates the pointer within the computer. The database memory is stored in one or more servers. When the user is desirous to store a file at the newly created address in WWW, it sends the file and address contained in the pointer to the server, the server stores the file at that address in data memory.

When the user is desirous to retrieve a file from WWW, creator sends the address of the file stored in the category memory to the server. The server retrieves the file at that address in data memory, and sends the file to the user computer.

In yet another version,

the Creator program is stored in a server connected to the WWW and to the users computer except for the keyboard and monitors which is located with the users computer. To retrieve an existing file, The user sends (through his computer) his identifying keywords (his “URL”) to the server, The server obtains from the domain name server, the database address associated with the “tag” (URL) and applies the address to sending the file from its address in database memory to the user's computer.

When the user wishes to store a new, modified or reviewed file, the file and the tag (of keywords) is sent from the computer to the server where Creator forms a new pointer being a combination of the tag and a new address. The pointer is stored in the domain name server and the file is stored in the database memory at the new address.

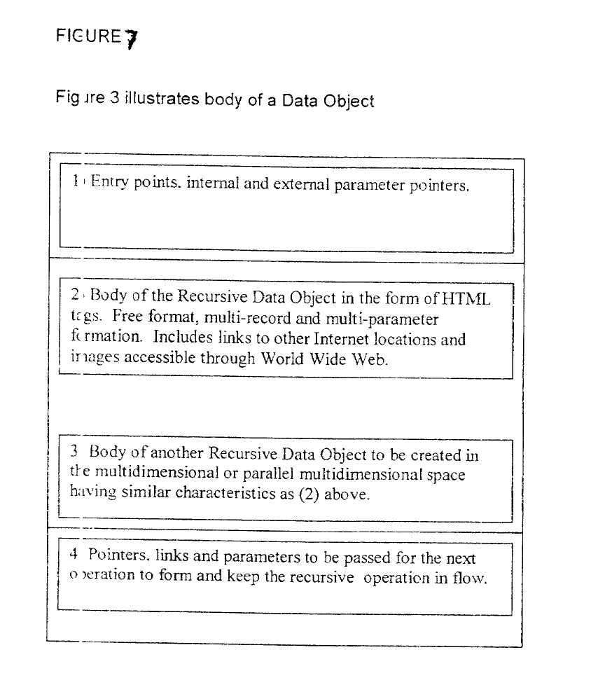

FIG. 4 shows another embodiment in which the apparatus is a computer 11 programmed with the software program (Creator) of the invention and connected through a server 13 to the Internet. The database memory 15 is one or more additional nodes (two are shown) of the Internet connected to the server 13. The server 13 is connected to a domain name server 19, which performs the functions of the category memory where database objects are located in the Internet.

A major feature of the invention is that a search engine on the Internet is not required to locate the database object (file).

The invention effects a considerable reduction in the complexity of the system. Furthermore, this arrangement permits expansion of a single data base memory onto additional nodes of the Internet or linking other nodes to the database management system.

The invention provides a database management system that is multidimensional by enabling database information to be mapped into multidimensional servers and allowing simultaneous operation through the multidimensional server hierarchy.

The user computer connected to a server on the Internet as shown in FIG. 4 is programmable to permit another user to establish an access to the database management system through the World Wide Web Internet communication and be linked to implement operations on the database objects. Such operations include create, store, search, retrieve, view, manipulate, restore and delete.

The computer is programmable to add a subrecord into a data object that performs operations including to create, to store, search, retrieve, view, manipulate, restore, and delete another single or multidimensional database object.

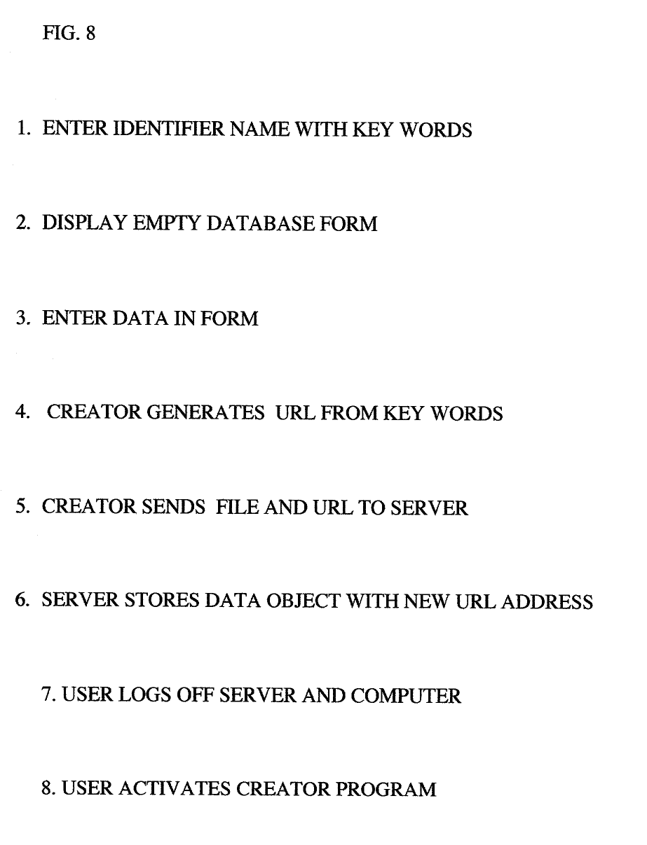

FIG. 5 illustrates the arrangement of the database memory when the database memory is self-contained in a single computer.

The database memory is divided into a group (column) of p partitions 20. Each partition 2e is divided into m segments 22. Each segment is divided into n sections. 24.

Each section 24 contains r data objects 26 where r grows as new data objects are added.

The file is a collection of one or more data objects stored in a section. As objects are added to the file, the file and number of files in one section grow until the files occupy one segment. As the size of the file continues to grow, it occupies more than one segment. With continued growth, the files occupy the entire partition, which is the entire memory of the computer. Then it becomes necessary to add additional memory capacity to the server or add additional severs to increase capacity. This property is referred to herein as the scalability characteristic.

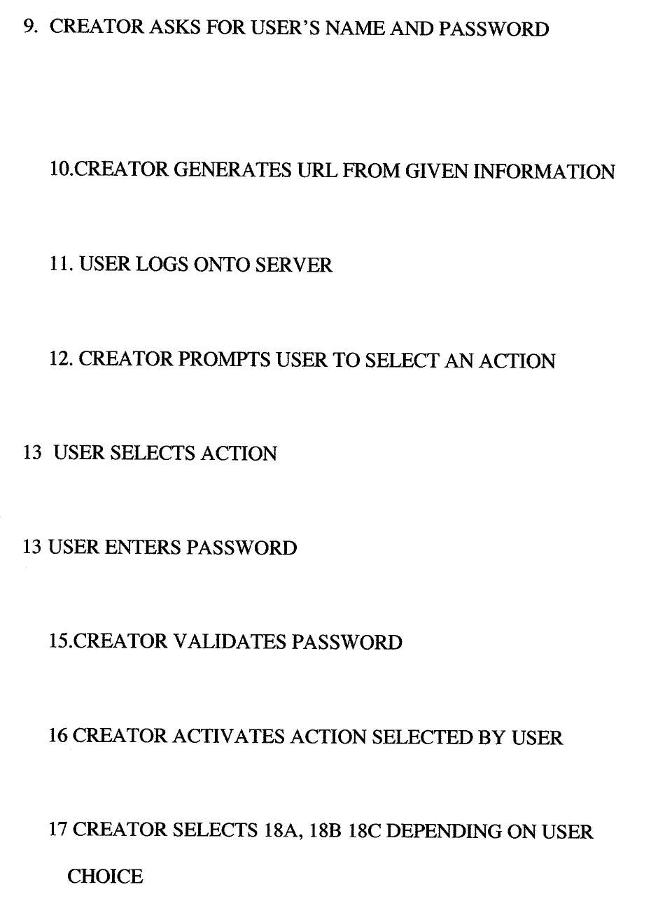

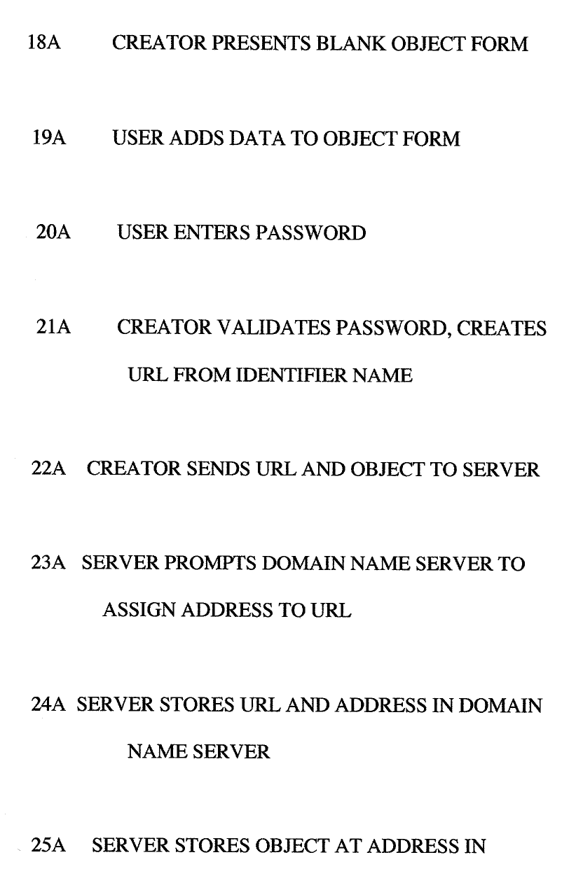

FIG. 6 is an arrangement in which each partition 20 is sufficiently large to assign a single partition to a single server 30 of a group of servers.

The group of tags represent the pointer, discussed with reference to FIGS. 1 and 2, in FIGS. 5 and 6 which defines the location of a selected file of one or more data objects. The group of pointers includes a partition pointer 31, a segment pointer 32, a section pointer 34 and a page pointer 36 to a page 38 holding the selected file 40.

When the hierarchy is distributed over a group of servers, 30 with one partition 20 in each server 30 as shown in FIG. 6, then, in one embodiment, the partition pointer 31 is an Internet address having any one of a number of formats. For example:

http://www.domain name.xxx.

or

ftp://www.domain name xxx

Domain name is a registered Internet domain name or host with approved agencies that serve global domain name registry.

or

http://nnn.nnn.nnn.nnn

A physical address of an Internet server on the World Wide Web hierarchy;

Or

ftp//nnn.nnn.nnn.nnn

A physical IP address of an Internet server on the World Wide Web hierarchy.

The segment pointer for the n^{th} segment is constructed by adding /segment number to the partition number containing the segment. For example,

Http//www.nnn/m points to the m^{th} segment in the partition having the domain name (server identification).nnn.

The section pointer 34 is constructed by adding /page to the segment pointer.

The section pointer /page tag points to a particular data base object. 36.

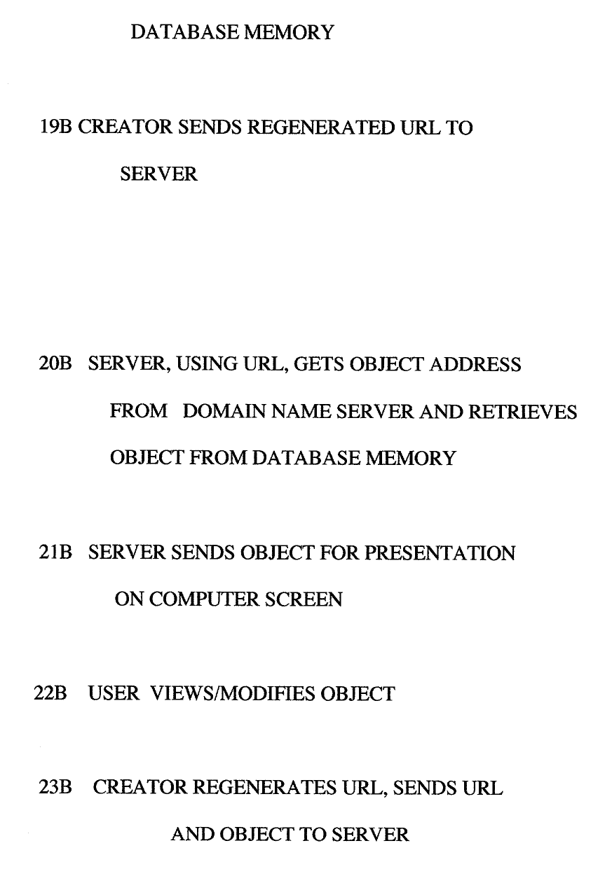

The data base object has a format and description as shown in FIG. 7. The creator program constructs the file pointer for data base accessing. The creator program creates the URL tags, then creates the body of the data base object 40 per user entry.

The Body of the data object has four sections.

(1) The first section lists the entry points and internal and external parameters

(2) The second section includes the body of the Recursive Data Object in the form of HTML tags and is written in free format, multi-record, and multi-parameter formation.

(3) The third section includes the body of another recursive data object to be created in the multidimensional or parallel multidimensional space having similar characteristics as (2) above.

(4) The fourth section includes pointers, links and parameters to be passed for the next operation to form and keep the operation in flow.

Once the user entry is complete, the database object 40 is immediately sent by the creator program to its new location on the hierarchy of the World Wide Web. Then the creator software prompts the user with the URL for reviewing or remanipulating the database object for its recursive operation.

The creator software contributes to the recursive operation. Since the database objects are always recreated, any database object at any given time can have reformation of its structure without effecting the content of any other object base that has already been positioned in the hierarchy.

There is no fixed description of the record type or record limit of the database object. content. Through recursive scalable operation, the body of a database object can have any record size from 0 to infinitely large number and can have any form of recent type.

The recursive and free format characteristics of the database object formation offers a flexible scalable and recursive content management of the hierarchy of the World Wide Web.

The body of the database object has no fixed record format and limit. Database management in this invention ensures manipulation of any type of record formation or file orientation by providing recursive and scalable data base formation in the hierarchy of the multidimensional World Wide Web.

The architecture uses indexing by forming an URL from user input by the creator software. Therefore, there is no need to use a search engine to find a database object crated by this invention. A “built in” search engine provides group search results according to the user requirements to find a set of data base objects having the same characteristics. The search operation is speeded up by examining the key words in the identifier name or “title” portion of the database object planted by the creator software into a category memory as each database object is created or recursively generated.

### EXAMPLE

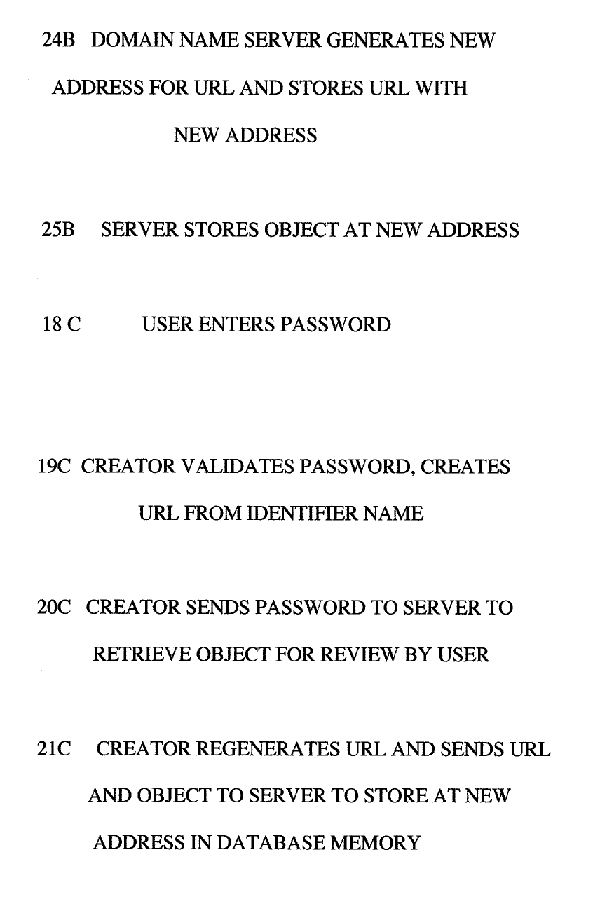

FIG. 8 is a flow chart listing steps in practicing the method of this invention on the Internet.

The initial condition is that a user has a computer, access to a server. He wishes to create a database system of this invention using the computer for management of the file of database objects that he intends to store in the server. Therefore he first has to create a database hierarchy (structure) in the server, Creating the hierarchical structure is accomplished in the following steps, 1-8.

In step 1, the user obtains a license to install and use the “creator:” software program of this invention in the computer. This includes entering into the computer an identifying (business) name, a password, and a title of the file that he wishes to operate. The title includes keywords related to the subject of the file and the title is used as a part of the tags. This information is entered in the form of a web address (http).

In step 2, the computer displays an empty database form.

In step 3, the user enters data in the database form.

In step 4, Creator generates an URL containing keywords entered by the user and using the title license licensed to the licensee. In step 1.

In step 5 the creator automatically sends the database object pointed by the URL the server.

In step 6, the server stores the data object with a new URL address (partition, segment section) address with in Internet space.

In step 7, the user logs off the server and computer.

Now that the file of objects has been created, provided with an address and file objects stored at the address in database memory of the server; the next action will be one of modifying or simply filing one or more objects in the newly created file. This is accomplished by steps 8-22.

In step 8, the user activates the Creator program by turning on the computer and connecting (logging on) to the server.

In step 9 the Creator asks for the user identifier information (name and password).

In step 10, Creator generates an URL from the user's identifier information.

In step 11, the user logs onto a server.

In step 12 Creator presents on the computer a query which asks the user to select an action being one of:

A. Create a new record (to be added to the existing file)?

B Retrieve an existing record for update and then restore the updated record?

C. Retrieve an existing record for review only.

In step 13: the user selects A, B, or C by pressing (clicking) on the appropriate button on the screen.

In step 14, The user enters his password on the computer screen

In step 15: Creator compares the entered password with the name and password entered by the licensing step 1 and if the password is not acceptable, the program returns to step 9.

In step 16: creator compares the entered password with the name and password entered by licensing step 1 and if the password agrees with the password on the license information, the program goes to step 18A or step 18B or step 18C depending on the selection of A, B, or C in step 12.

In step 18A (creating a new object for addition to the existing file)

The Creator program presents an object form on the screen as shown. Some of the records in the form are blanks to be filled in by the user and other records have been selected by creator using key words that have been buried in the business name (category) of the user in step 4.

In step 19A the user adds/modifies data to the object form thereby creating a new object.

In step 20A the user enters his password.

In step 21A if the password is validated by Creator, Creator creates a URL (tag) from the user information.

In step 22A: Creator sends the object and URL to the server using the URL generated by the Creator.

In step 23A, server prompts the domain name server to access the Internet space pointed by the URL.

In step 24A, server stores data object pointed by the URL.

In step 25A: Server stores object at the address in database memory pointed by the URL.

In step 18B: Creator sends the regenerated URL to the server.

In step 19B, server, using the regenerated URL to access the previously stored object from database memory, sends the object back to the computer.

In step 20B: The object is presented on the computer screen as shown in FIG. 3.

In step 21B: The use modifies records of the object:

In step 22B: Creator regenerates the URL from identifier information of step 1 and sends URL and object back to the server;

In step 23B: Domain name server generates a new address, (partition, segment, and server) for the data object and stores the data object pointed by the URL in database memory.

In step 18C Creator, using the regenerated URL, to select the previously stored object. Locates the object for review and sends the previously stored object from the server back to the computer for review;

In step 19C user enters his password.

In step 20C, Creator validates the password and creates an URL from the identifier name.

In step 21C, Creator sends the URL to the server to retrieve the object and send it back to the user for modification/review.

In step 22C, Creator regenerates the URL and sends the data object back to the where it is pointed by the URL for storage in database memory.

The example illustrates the principles of the invention applied to its incorporation in a computer and the World Wide Web. The use of a search engine on the World Wide Web is eliminated by the use of the category memory to store key words from an identifier name to create and URL and the use of a domain name server to assign a database address to the URL for storage and retrieval purposes.

Variations and modifications of the invention may be contemplated after reading the specification and studying the drawings that are within the scope of the invention. I therefore wish to define the scope of my invention by the appended claims

I claim:

1. A database management system for enabling a user having an identifier name to create and enter data into a user file in a data base memory wherein the file has an unlimited number of objects and records, and the user is enabled to modify data of the user file, modify format of the objects, review data of the file, said system comprising:
a data base memory (22);
a device (12) for enabling a user to enter an identifier name containing keywords into the system;
a tag generator (14) arranged to generate a tag from said keywords;
a select means (16) for permitting the user to select one of:
A. creating and adding a new file;
B. viewing and modifying an existing file in said database memory;
a monitor for displaying any one of:
(a) a blank object form;
(b) an existing file from said database memory;
means for enabling said user to supply data to said blank object form when said user selects creating and adding a new file;
means for enabling said user to modify said existing file in said database memory when said user selects modifying said existing file;
a pointer generator (18) for constructing a file pointer including said tag and an available database address;
means for applying said file pointer to storing a file at said available database address in said database memory when any one of:
(I) said file is an existing file retrieved from said database memory for review and modification;
(2) said file is a newly created file;

2. A computer containing a program for managing data in a database memory which comprises:
a keyboard (12) for enabling a user to enter an identifier name containing keywords into the system;
a tag generator (14) arranged to generate a tag from said keywords;
a select means (16) for permitting the user to select one of:
A. creating and adding a new file to said database memory;
B. viewing and modifying an existing file in said database memory;
a monitor for displaying any one of:
(a) a blank object form;
(b) an existing file from said database memory;
menu means presented on said monitor for at least one of:
(i) adding data to said blank object form; and
(ii) modifying said retrieved file;
a pointer generator (18) for constructing a file pointer including said tag and an available database address;
means for applying said file pointer arranged for storing a file at said available database address in said database memory when any one of:
(I) said file is an existing file retrieved from said database memory;
(2) said file is a newly created file.

3. The database management system of claim 2 comprising:
at least one server arranged for storing said database memory;
said computer communicating with said at least one server for storing and retrieving files of said database memory.

4. The database management system of claim 2 wherein said computer comprises said database memory.

5. The database management system of claim 3 wherein:
said computer contains said keyboard, said monitor,
said at least one server contains said tag generator, said select means, said menu means, said pointer generator, said means for applying;

6. The database management system of claim 4 wherein said at least one server and said computer are connected to the Internet.

7. The database management system of claim 6 wherein said identifier name is a website address of said user.

8. The database management system of claim 6 wherein said identifier name is written in HTML formats.

9. The database management system of claim 6 wherein objects of retrieved files are arranged in the form of Hyper Text Markup Language and are displayed in a form understandable by said user.

10. The database management system of claim 4 wherein:
each one of said at least one server contains one partition of database memory;
each partition has a partition address;

11. The database management system of claim 2 wherein:
said program arranges said database memory to provide that
(i) said database memory includes at least one partition;
(ii) each one of said at least one partition includes at least one segment;
(iii) each one of said at least one segment includes at least one section.

12. The database management system of claim 11 wherein:
each one of said at least one section contains at least a part of at least one object of a file;
each one of said at least one segment contains at least a part of an object of a file;
each one of said at least one partition contains at least a part of at least one object of a file;
said program arranged to permit addition of data to any one of said at least one file and extend anyone of said at least one file:from any one of
(i) said at least one sections to another one of said sections within said respective segment;
(ii) from any one of said at least one segment to another one of said segments within a respective partition;
(iii) from said at least one partition to another one of said at least one partition. as data is added to said at least one file whereby said memory is scalable.

13. The database management system of claim 12 wherein each one of said at least one partition occupies at least one server and when a size of any one partition grows to occupy an entire memory of a respective server, said program is arranged to extend said any one partition into an additional server.

14. The database memory of claim 2 wherein said program in said computer is arranged to assign said database memory to anyone of a computer and at least one server wherein any one file stored in said database memory is expandable from a section to a segment to a partition of computer memory
and from at least a partition of one server to at least one partition of a plurality of servers as additional data is added to said file.

15. The database memory of claim 2 wherein said means presented on said monitor for enabling said user to modify said retrieved file is recursive and dynamic.

16. The computer containing the program of claim 2 wherein said object has a format, said format comprising:
a plurality of entry points and internal and external pointers;
a body of a recursive data object in the form of HTML with links to other internet locations and images accessible through the World Wide Web;
a body of another recursive data object when said another recursive data object is created in the multidimensional space and in the form of HTML with links to other internet locations and images accessible through the World Wide Web;
a plurality of pointers, links and parameters for a next operation to form and keep recursive operation in flow.
